(19) United States
(12) Patent Application Publication
(10) Pub. No.: US 2016/0066169 A1
(43) Pub. Date: Mar. 3, 2016

(54) EMERGENCY RESPONSE SYSTEM

(71) Applicant: Dale J. LUGER, Centralia, WA (US)

(72) Inventor: Dale J. LUGER, Centralia, WA (US)

(21) Appl. No.: 14/468,883

(22) Filed: Aug. 26, 2014

(51) Int. Cl. H04W 4/22; H04W 4/02

(52) U.S. Cl. CPC H04W 4/22; H04W 4/021

(57) ABSTRACT

An improved emergency response system.

### CROSS-REFERENCE TO RELATED APPLICATION

None.

### BACKGROUND OF THE INVENTION

The subject matter of this application generally relates to geodesic location (“GL”) methods and systems, and to those methods and systems that employ global mapping, in which the earth's surface is divided into small areas identified by a numeric designator. More specifically, the present disclosure is directed to methods and systems that utilize geodesic location systems for emergency response.

Global Positioning System (“GPS”) became popular with back-country hikers approximately twenty to thirty years ago. However, in order to use these GPS systems, a user was typically required to possess a physical map upon which the user could associate latitude and longitude coordinates with a GPS location. Subsequently, GPS systems were installed as navigation systems in luxury vehicles to provide directions to a destination demarked as a street address. However, inputting the destination in the form of a street address is slow and burdensome. Most recently, some modem cell phones are also equipped with GPS systems; however, use of these cell phones as a navigation device may again be cumbersome due to the difficulty of entering a street address, such as “23456 Martin Luther King Blvd, SW, San Francisco, Calif.” into a cell phone.

What is desired, therefore, is an improved geodesic location system.

### BRIEF DESCRIPTION OF THE DRAWINGS

For a better understanding of the invention, and to show how the same may be carried into effect, reference will now be made, by way of example, to the accompanying drawings, in which:

FIG. 1 is a map of a portion of the earth's surface, specifically of a portion of North America, showing successively smaller divisions into a grid of country, state, subsection, and destination squares.

FIG. 2 illustrates the format of the instant numbering system.

FIG. 3 shows an improved emergency response system.

FIG. 4 shows an alternative improved emergency response system.

FIG. 5 shows an improved emergency response system for a feature phone.

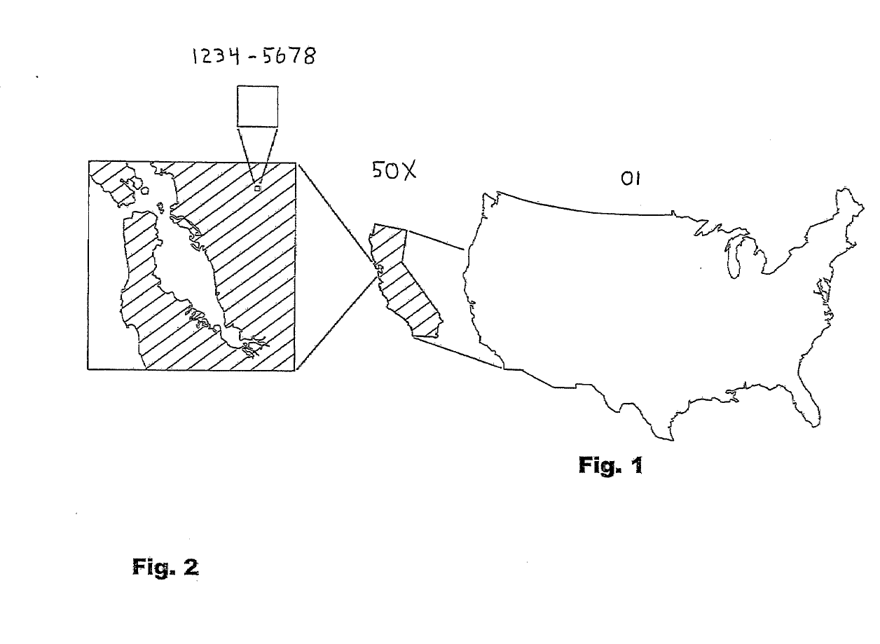

### DETAILED DESCRIPTION

Commercial use of geodesic locator systems has been impeded due to either (1) the awkwardness of determining and expressing a location using coordinate-axis systems like longitude and latitude, or (2) the difficulty of inputting desired coordinates as a destination in a location device such as a cell phone, or both. This is particularly problematical with respect to emergency response systems where locating a person as rapidly as possible is often critical.

It is usually difficult, for example, to monitor a person's location in a coordinate axis system, e.g. latitude and longitude, without the assistance of a device such as a GPS monitor, which constantly tracks the device's location via satellites. Moreover, due to the coarseness of the resolution of these types of coordinate-axis systems over the globe, exact locations can only be denoted using a very long string of digits or characters—typically numbering more than twenty characters.

Other geodesic location systems suffer from similar flaws, including Universal Transverse Mercator (UTM), United States National Grid (USNG), Natural Area Coding System (NAC), Military Grid Reference System (MGRS), decimal degrees, degrees and minutes and seconds, meters, feet, etc. Many of these systems utilize alphanumeric characters, so as to reduce the number of characters necessary to express a location, yet each still is inconvenient when desiring to communicate a location to another through a user interface of a device such as a cell phone.

To illustrate these drawbacks of conventional geodesic location systems, the Empire State Building's location might be described, for example, as:
350 Fifth Avenue,
New York, N.Y. 10118-0110
   or:
Latitude: 40.7484304750542
Longitude: −73.9857770519262
   or:
(UTM) Universal Transverse Mercator Coordinates
18N Easting: 585,878.88 Northing: 4,502,849.76
   or:
(MGRS) Military Grid Reference System:
18TWL8587802849
Section: 18
Sub Section: T
Map Section: WL
Map Point: 8587802849

Employing alpha characters creates a multitude of problems that are not a factor in numeric (only) systems. Such problems include difficulty in use across different languages and especially languages that do not use characters such as are used in Latin and Anglo/Germanic based languages. Use of alphanumeric symbols also creates confusion in voice recognition of characters due to similarity in pronunciation between alpha characters, such as the difficulty in distinguishing between “B” and “D,” “P” and “T,” “F” and “S.” Also, the screen area on a cell phone is too small to have a touch screen with alpha characters. A multitude of dialects further worsens the recognition problem.

As a result of these difficulties, each country has adopted its own methodology in which to identify specific locations within their country, which also may vary by application. Thus, GL systems are used in vehicles, cell phones and PDA's need to be revised for each country to accommodate their language and geodesic locating technology, etc.

Voice recognition in GL devices in many cases does not work well when inputting addresses. For example, some voice recognition software only works properly when speaking in sentence structures, cannot discern the correct spelling of formal names, cannot differentiate between homonyms such as “eight” or “ate”, cannot differentiate between “Fifth” Street and “5^{th}” St, and so on. In addition, road noise while driving also often interferes with voice recognition software.

The present inventor realized that an improved GL system could be established that used only numerical characters, and could associate a unique location of approximately 20×20 meters, i.e. a “viewable” distance, with a unique number having a length sufficiently small as to be easily memorized, expressed, and typed into a keypad. Thus, the improved GL system would not be language dependant, and could be used to easily input a desired destination into any GL device. The improved GL system is capable of uniquely identifying all street addresses throughout the world, and is also capable of locating a specific location even when no street address is assigned.

The disclosed GL system is derived by dividing the land areas of the earth, and in some embodiments the sea, into a natural grid guided by political boundaries and increased areas of influence. Every grid location on earth is identified by a numeric string of no more than 13 digits and in practical use by 8 or 9 digits, which are easily input with a 10-key pad and easily recognized with voice input.

The number of digits required for the numbering system of the present invention is small because the earth's land surface has been subdivided generally into squares 20 meters on a side. For purposes herein and for brevity of description, the numbering system of the present invention will be referred to as the QuickFind, or QF numbering system. Thus, the achievement of the QF numbering system is in making it easy to find a specific property or person by directing the user to within 20 meters (the equivalent of a semi-truck) of his desired location. Placing the user within at least 20 meters is sufficient to locate any destination point (even off road). Once on a given street, the user doesn't continue to look at his geo locator; he typically uses the building numbers to find the address he wants or he may otherwise visually locate the desired location.

The locating 13 digits of the instant QF numbering system utilizes are separated similar to the United States' 11 digit telephone numbering system. For example, a telephone numbering is of the format 1 (XXX) XXX-XXXX The QF Numbering is of the format (01) 481-XXXX-XXXX. The QF numbering system has been purposefully formatted so as not to be confused with a telephone number.

As with telephones generally, practical use is improved when the system recognizes political boundaries familiar to users, such as countries and states or provinces. The QF system assigns a two-digit country code to one large country or to several smaller countries. The next two digits may be assigned to the states or provinces of each country. Depending upon their geographic size, some states or provinces can be combined or divided into 2 or more QF codes. As an example for the United States; the states may be numbered starting from the east-to-west. Maine may be designated as “01;” New Hampshire designated as “02” etc. Because of their size, larger states may divided into two QF codes. Texas may be designated with “37” and “38;” Montana may be designated as “39” and “40;” California may be designated as “50” and “51;” and Alaska designated as “52” and “53.” Thus, the first portion of the QF numbering system is quite easy to interpret. The area code of 01(50X) in the foregoing illustration could be United States, Northern California, for example, where the “X” designates any digit from 0 to 9. The examples given above regarding the order in which countries and/or states are assigned in sequence to a numerical code is of course illustrative as many other methods ca be used to assign a two digit code to the countries in the globe, the states or provinces in a country, etc.

Each state or province may then be subdivided into sub-regions, which may typically be any shape, with the sub-region being no greater than 40,000 square kilometers. This is the maximum area that can be subdivided into squares twenty meters on a side using only eight digits. For all purposes herein, these squares will hereafter be called destination areas, or destinations. The fifth digit in the QF numbering system refers to a specific subsection, which may have a natural geographical significance or population concentration. The region and the sub-region codes may together be referred to as the “region code.” Thus, for example the Puget Sound Area of Washington State could be designated as 01(481) XXXX-XXXX; or the San Francisco Bay Area of California could be designated 01(506) XXXX-XXXX; and the Los Angeles/San Diego area could be designated by 01(516))000(-XXXX.

For convenience of use, the QF region and subregion digits will remain constant in the users GL device until it is changed. The GL user will only have to change these numbers if the user leaves the region. For example, the Empire State Building could be identified with a QF number of 01(072) 7207-3983, 01=United States; 07=New York State; 2=New York City; 7207−3983=350 Fifth Avenue. The GL user in the New York area would simply input 7207-3983 and their GL device to take them directly to the Empire State Building.

The instant system depends on users knowing or obtaining necessary destination numbers. Those location numbers will be available on an Internet web site or from other QF users. By simply inputting a destination, a user receives his location number. In practice users memorize their location number the same way they do their telephone number or Zip Code. When asked for directions to their home or their office, they simply give their 8 digit location number.

Assuming a GL device that embodies the QF numbering system has been activated either manually or through voice activation, the user simply inputs a destination number, at most 13 numbers and normally eight or nine numbers, either manually on a device key pad or by voice recognition, and then proceed as directed by the GL device.

Preferably, the disclosed GL numbering system facilitates an improved method to input desired destinations into many different types of devices such as vehicles, cellular phones, and PDA's, which can also easily use the QF numbering system. By simply inputting the required 8-9 digit destination code, the cell phone will direct the user to his desired location.

The numeric based geodesic locator system of the present invention includes a geodesic grid conceptually dividing the earth into sections on land and on sea. Each of the sections on land has region boundaries that follow political boundaries generally. The political boundaries and thus region boundaries at least in part include boundaries of countries, boundaries of states or provinces or other similar divisions of country boundaries.

As described above, the system is largely based on an exclusively numeric code that uniquely designates each of the sections. The system is configured to receive input of the numeric code from a user that wishes to locate a destination, which he does by entering the code for that destination. The user then is guided to the destination using any of several available global position systems. The code comprises only numeric characters that are uniquely formatted with a string of no more than thirteen numeric characters.

It is normal that a user will routinely operate within a same sub-region. Therefore, the GL system of the present invention will automatically enter the first five digits of the destination as identified by the current location of the GL device. As a result, the user will only be required to input the remaining eight digits if the destination point is located in the same sub-region. The GL user will only have to change the first numbers if he leaves the sub-region.

Because numerals are easily recognized uniquely without confusion by voice, the system further comprises voice recognition to allow hands free operation with the code input of the string of numerals is entered by voice.

So the user can easily confirm the accuracy of his input, the system returns the nearest street address to an entered destination, either by displaying the address alphanumerically or by designation on a map, or both, or conceivably by voice.

The system is intended to be employed in vehicles, in fixed locations, or in a handheld device. With the increasing development of cell phone capability, the system may also be integrated into a cell phone.

GL devices need a user friendly method of inputting virtually any location on earth. Not only will such a concept dramatically improve the mobility and efficiency of society, it can be used to improve the safety of the public as well by easily and quickly guiding emergency vehicles to a destination.

One beneficial application of QF numbers is to facilitate response after a request for emergency assistance. For example, when a person dials 911 from a cell phone, the call is received by a local cell tower and routed to call center, who uses the location of the cell tower as a reference to direct the call to an emergency response dispatcher close to the receiving cell tower. The dispatcher may then be connected to the caller who may inform the dispatcher of their actual location, which in some instances might not be known to the caller. Furthermore, in some instances, valuable time is wasted when the cell tower at which the phone call is received is the closest to the caller, but the cell tower is in a different emergency response zone than is the caller. In such an instance, the emergency dispatcher first receiving the call does not know that the call was misrouted until the dispatcher speaks with the caller and receives their actual location.

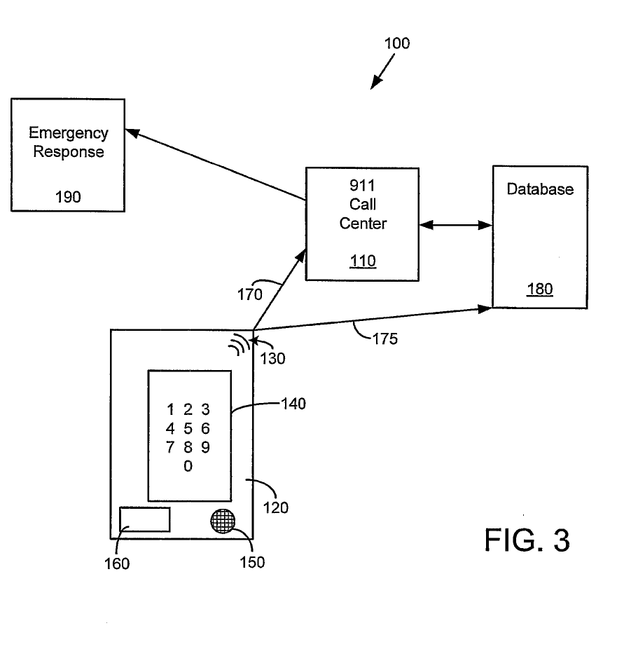

Referring to FIG. 3 an improved emergency response system may include a 911 call center 110 capable of receiving an emergency call, or other communication such as a text message, from a cell phone 120 or other portable communication device such as a PDA, smartphone, etc. The cell phone 120 preferably includes a transmitter/receiver 130, a keypad 140, a microphone 150, and memory storage 160.

The cell phone 120 preferably includes firmware or software, such as a downloadable application, that is capable of rapidly communicating the location of a user to an emergency responder in the case of an emergency. Specifically, the cell phone 120 preferably receives GPS location information, such as latitude and longitude coordinates, through the transmitter/receiver 130 and that information is used to convert the GPS location information to a current QF location number, stored in memory 160 and/or in an online database, including a remote server such as a “cloud” server. In some embodiments, the cell phone 120 may convert the latitude/longitude information to a QF location number, while in other embodiments this conversion may be done by a remote server or other device. When a user dials 911 or otherwise instantiates a communication to an emergency call center or an emergency responder through channel 170, the cell phone 120 preferably simultaneously automatically sends the current QF number stored in memory 180 to the 911 call center 110. Automatic sending of the QF number is beneficial for a variety of reasons, such as avoiding the time of verbally communicating the number, eliminating errors in typing the number, and communicating a QF number in the event that the user of the cell phone cannot speak.

Upon receipt of the QF number, the 911 call center 110 can then convert the QF number to a geographical location on a map, such as a street address, and communicate that information to an emergency responder 190. The 911 call center 110 may also communicate the QF number to the emergency responder 190, which may preferably have a navigation device 190 capable of directing the emergency responder to the user of the cell phone 120. Preferably, the cell phone 120 continues to transmit the current QF number to the 911 call center for as long as the communication channel 170 is open, in the event that the user of the cell phone 120 is moving. A new or updated QF number could be transmitted at appropriate intervals, for example every 10-30 seconds.

In some instances, the cell phone 120 may not be capable of converting coordinates received from a GPS to a QF number. In such a circumstance, the cell phone 120 may, simultaneously upon dialing 911 transmit the GPS coordinates to a database 180, which may then convert those coordinates to a QF number, and the database then may transmit the QF number to the 911 call center.

In some embodiments, users would be able to input and store emergency information about themselves into the memory storage 160 of the cell phone 120. When dialing 911 or otherwise initiating a communication with an emergency responder or emergency call center, the information could be used to further assist the emergency responders. For example, the information could include blood type, known medical conditions or allergic reactions, emergency contact information used for obtaining consent for procedures, etc. The information could also include home and work addresses, etc. in the case that a QF number was unobtainable. The information could be sent as a text message or sent in another format, such as a data entry field format used by a medical industry in the region where the disclosed system is being used. In some embodiments, dialing 911 or otherwise contacting an emergency responder could be triggered by a “panic button” or other shortcut procedure, and in this stance, the additional emergency information may also be sent automatically as well. Preferably, the additional emergency information is sent only in response to a user dialing 911.

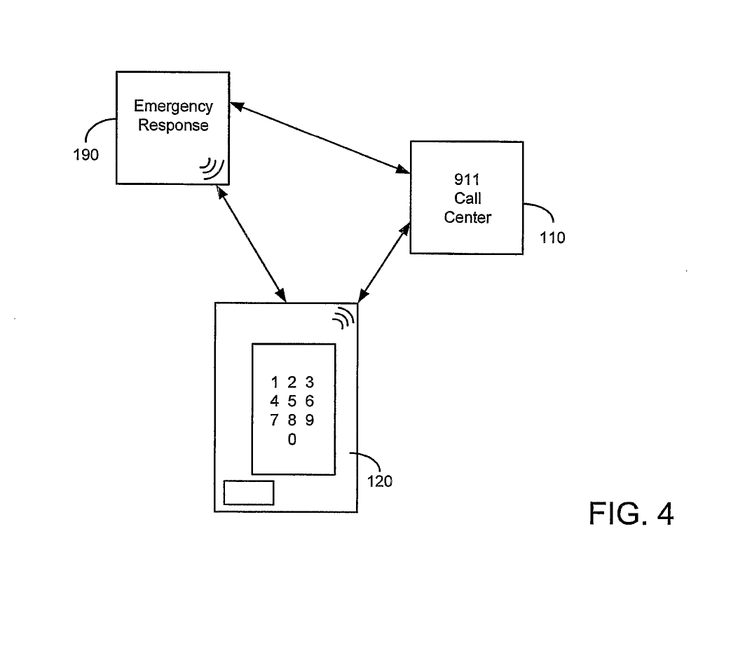

Oftentimes, a person requiring emergency assistance is not stationary. For example, a person suffering a heart attack may be in a car or other moving vehicle being driven by a friend or relative, and it would be beneficial for an emergency responder and the moving vehicle to drive towards and meet another, to save time. Referring to FIG. 4, a cell phone 120 may initiate a 911 call or other emergency communication to a call center and thereby obtain and communicate a QF number to the emergency responder 190, as with respect to FIG. 3. However, the emergency responder 190 may also communicate a second QF number, representative of the current location of the emergency responder to the 911 call center, which may then transmit the second QF number to the cell phone 120. Preferably, the cell phone 120—like the emergency responder 190—is able to convert the second QF number to a geographical location, such as a street location or block, or more preferably, may simply use the received QF number to display the current location of the emergency responder on a map so that the emergency responder and the moving vehicle can track each other as they move closer together.

Many cell phones/mobile devices sold today in the United States, Europe, and other industrialized countries fall into the category of “smart phones”—i.e. phones that have programmable APIs that permit the user to install applications (or apps) downloaded from third parties onto the phone. Smart phones also typically include web browsers and e-mail applications that are capable of functioning in a manner commensurate with browsers and e-mail applications of desktop computers. The functionality of the cell phone 120 just described can be implemented by such software. However, many cell phones (known colloquially as feature phones) do not include the ability to install and run software, nor do they include web browsers and e-mail applications. Thus, the present inventor realized that it would be beneficial to nonetheless provide feature phones with functionality that would enable the communication of a QF number from a feature phone to an emergency responder upon dialing 911.

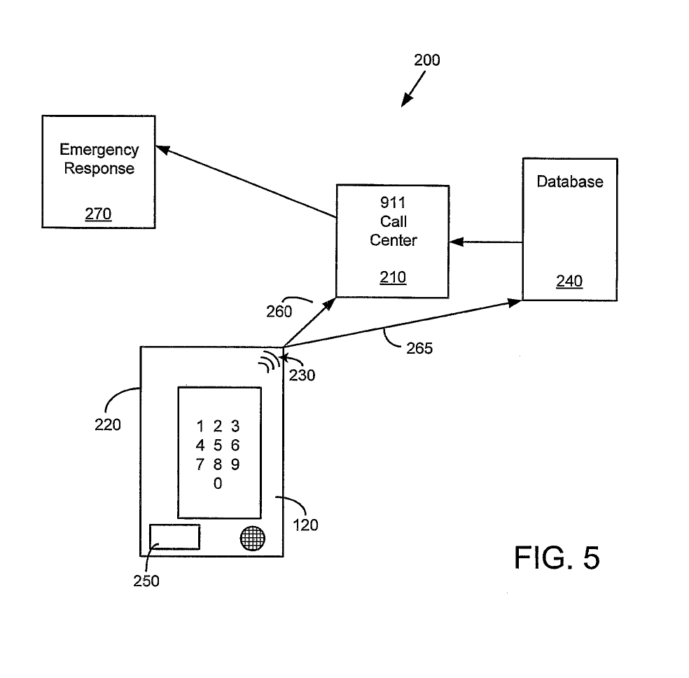

Although feature phones may not include programmable APIs and web browsers/email, many feature phones do include GPS locators and the ability to send text messages. Referring to FIG. 5, system 10 may include a 911 call center 210 that receives a 911 call from a feature phone 200 through a communication channel 260. The feature phone 220 is capable of receiving latitude/longitude coordinates received from a GPS device through the receiver/transmitter 230, which may be stored in memory 250. Simultaneously with instantiating the 911 call, the feature phone may send the latitude/longitude coordinates to a database 240 via a text message sent through a communication channel 265. The database 240 may then convert the latitude/longitude coordinates to a QF number, transmit the QF number to the 911 call center 21, which may then forward it to an emergency responder 270.

In some embodiments, a pair of smart phones (or other devices) may be equipped with the functionality to transmit the of location of one phone (or other device) directly to the destination field of the second phone (or other device) so as to allow persons to more conveniently give directions to a current location. In other embodiments, it may be desirable to insert a user's QF number into each text message sent by a user. This functionality may be turned on or off by the user, and may be beneficial in instances where the user becomes missing, for example, and could thus possibly be located using the location indicated by their last text message.

One common protocol for sending text messages is the Short Message Service (SMS), which uses standardized communications protocols to allow fixed line or mobile phone devices to exchange short text messages. SMS was the most widely used data application, with an estimated 3.5 billion active users, or about 80% of all mobile phone subscribers at the end of 2010. The term “SMS” is used for both the user activity and all types of short text messaging in many parts of the world. Though most SMS messages are mobile-to-mobile text messages, support for the service has expanded to include other mobile technologies, such as ANSI CDMA networks and Digital AMPS, as well as satellite and landline networks.

SMS messages are sent to a short message service center (SMSC). Transmission of short messages between the SMSC and the handset is limited in payload length by the constraints of the signaling protocol to precisely 140 octets (140 octets*8 bits/octet=1120 bits). Short messages can be encoded using a variety of alphabets: the default GSM 7-bit alphabet, the 8-bit data alphabet, and the 16-bit UCS-2 alphabet. Depending on which alphabet the subscriber has configured in the handset, this leads to the maximum individual short message sizes of 160 7-bit characters, 140 8-bit characters, or 70 16-bit characters. GSM 7-bit alphabet support is mandatory for GSM handsets and network elements, but characters in languages such as Arabic, Chinese, Korean, Japanese, or Cyrillic alphabet languages (e.g., Russian, Serbian, Bulgarian, etc.) must be encoded using the 16-bit UCS-2 character encoding (see Unicode). Routing data and other metadata is additional to the payload size.

Because of the character limitation on SMS text messages, it may be desirable to allow the user configuration options for sending QF numbers in every text message. For example, in a first configuration option, the user prioritizes the content of the text messaging such that a QF number is sent only if there is space remaining after the user types the message. In a second configuration option, the user prioritizes the sending of a QF number, such that the permitted character length is shortened for every text message. In some embodiments, the permitted length of the text message in either of the two configuration options may be expanded by enabling “long SMS” (or concatenated SMS/multipart or segmented SMS) which uses multiple messages to send a single transmission. In this variation, each message may start with a User Data Header (UDH) containing segmentation information. Since UDH is part of the payload, the number of available characters per segment is lower: 153 for 7-bit encoding, 134 for 8-bit encoding and 67 for 16-bit encoding. The device receiving the messages then reassembles the message and presents it as one long message.

In some embodiments, the cell phone 120 may include functionality that permits a user to highlight a region on a displayed map, such as Google Maps, and then download all the QF numbers for the highlighted area so as to allow access to QF numbers even when the user does not have satellite reception. The cell phone 120 could therefore be equipped to convert a GPS coordinate to a QF number. This could be useful, for example, in an emergency situation where two people are traveling together who have different cell phone providers where one gets reception, but lacks software to convey QF numbers or GPS data, and the other does not get reception but is able to use on-board software to determine a QF number, which may then be verbally communicated to an emergency dispatcher or other person. In some embodiments, the software may not only determine a QF number from GPS data, but also an average ground elevation for the area. In this manner, receipt of elevation information from the cell phone could be used to determine what floor of a building a person is on by approximating the elevation of the ground floor of the building.

In some embodiments, a feature phone lacking the software or hardware to compute and display turn-by-turn navigation to a user may be provided that functionality remotely. For example, a feature phone could transmit to a database a QF number of a desired destination along with a continuously-transmitted QF number of the feature phone. The database could then text directions to the feature phone until the destination is reached.

It will be appreciated that the invention is not restricted to the particular embodiment that has been described, and that variations may be made therein without departing from the scope of the invention as defined in the appended claims, as interpreted in accordance with principles of prevailing law, including the doctrine of equivalents or any other principle that enlarges the enforceable scope of a claim beyond its literal scope. Unless the context indicates otherwise, a reference in a claim to the number of instances of an element, be it a reference to one instance or more than one instance, requires at least the stated number of instances of the element but is not intended to exclude from the scope of the claim a structure or method having more instances of that element than stated. The word “comprise” or a derivative thereof, when used in a claim, is used in a nonexclusive sense that is not intended to exclude the presence of other elements or steps in a claimed structure or method.

1. A communications device comprising:
(a) a transmitter capable of opening a communication channel to an emergency response center;
(b) a receiver capable of receiving location information representative of the geographical location of the communications device;
(c) a memory for storing location data representative of said geographical location; and
(d) a processor that automatically transmits said location data to said emergency response center when said transmitter opens said communication channel to said emergency response center.

2. The device of claim 1 where said location data is a QF number.

3. The device of claim 2 where said processor receives latitude/longitude coordinates from a GPS signal and converts said latitude/longitude coordinates to said QF number.

4. The device of claim 1 where said location data is latitude/longitude coordinates.

5. The device of claim 4 where said processor transmits said latitude/longitude coordinates to said emergency response center indirectly through a database capable of converting said latitude/longitude coordinates to a QF number.

6. The device of claim 1 where said processor automatically transmits said location data at regular intervals while said communications channel is open.

7. The device of claim 1 where said location data is sent in a text message.

8. The device of claim 1 where said communications channel is a voice channel and said location data is sent over said voice channel.

9. A method comprising:
(a) receiving a QF number specifying the location of a person in need of assistance;
(b) using said QF number to determine a geographical location of said person; and
(c) relaying said geographical location to an emergency responder.

10. The method of claim 9 where said QF number is received from said person in need of assistance.

11. The method of claim 9 where said QF number is received from a database capable of converting latitude/longitude coordinates to a QF number.

12. The method of claim 9 including the step of relaying said QF number to said emergency responder.

13. The method of claim 12 including the step of receiving a second QF number representative of a location of said emergency responder and relaying said second QF number to said person in need of assistance.

14. The method of claim 9 where said QF number is received in a text message.
